(19) United States
(12) Patent Application Publication
(10) Pub. No.: US 2026/0277216 A1
(43) Pub. Date: Sep. 17, 2026

(54) ELECTRONIC APPARATUS AND CONTROL METHOD FOR DRIVING STATE CONTROL BASED ON LIFTING AND PLACEMENT

(71) Applicant: SAMSUNG ELECTRONICS CO., LTD., Suwon-si (KR)

(72) Inventors: Woongji KIM, Suwon-si (KR); Jaehong JEON, Suwon-si (KR); Gohwoon JEONG, Suwon-si (KR); Dosung JUNG, Suwon-si (KR)

(73) Assignee: SAMSUNG ELECTRONICS CO., LTD., Suwon-si (KR)

(21) Appl. No.: 19/674,501

(22) Filed: May 12, 2026

Related U.S. Application Data
(63) Continuation of application No. PCT/KR2024/016637, filed on Oct. 29, 2024.

(30) Foreign Application Priority Data
Nov. 13, 2023 (KR) 10-2023-0156205

(51) Int. Cl. G05D 1/246; G01C 21/20; G05D 101/15; G05D 107/40; G05D 111/50

(52) U.S. Cl. CPC G05D 1/2465; G01C 21/206; G05D 2101/15; G05D 2107/40; G05D 2111/52

(57) ABSTRACT

An electronic apparatus and a control method thereof are disclosed. The electronic apparatus operates in a first driving state in which the electronic apparatus moves based on a first map of an area in which the electronic apparatus is located. The electronic apparatus identifies whether the electronic apparatus was lifted while operating in the first driving state. Based on identifying that the electronic apparatus was lifted, the electronic apparatus obtains information about a height at which the electronic apparatus is placed after being lifted based on a sensing value obtained from at least one sensor. When the height is within a first range, the electronic apparatus operates in a second driving state in which a speed of the electronic apparatus is limited to less than a first value. Accordingly, the electronic apparatus controls a driving state based on the height at which the electronic apparatus is placed after being lifted.

### CROSS-REFERENCE TO RELATED APPLICATIONS

This application is a bypass continuation application of International Application No. PCT/KR2024/016637, filed on October 29, 2024, which claims priority to Korean Patent Application No. 10-2023-0156205, filed on November 13, 2023, in the Korean Ministry of Intellectual Property, the disclosures of which are incorporated by reference herein in their entireties.

### BACKGROUND

### 1. Field

The disclosure relates to an electronic apparatus and a control method therefor, and more particularly, to an electronic apparatus that identifies a driving state according to a location of a space wherein the electronic apparatus is placed if lifting of the electronic apparatus is detected, and a control method therefor.

### DESCRIPTION OF RELATED ART

An artificial intelligence system is a computer system that implements intelligence at a human level. The system is configured such that a machine learns and makes determinations autonomously, and exhibits an improved recognition rate as usage increases.

Artificial intelligence technology generally includes machine learning (e.g., deep learning) technologies, that use algorithms which autonomously classify and learn characteristics of input data, and element technologies that simulate functions of the human brain, including cognition and decision making, by utilizing such machine learning algorithms.

Element technologies may include at least one of the following: a linguistic understanding technology configured to recognize languages and characters; a visual understanding technology configured to recognize objects in a manner similar to human vision; inference/prediction technology configured to determine information and perform logical inference and prediction; a knowledge representation technology configured to convert information derived from human experiences into knowledge data; and an operation control technology configured to control movements of robots. In particular, visual understanding technology may be configured to recognize and process objects in a similar manner to human vision. Such visual understanding technology may include, for example, object recognition, object tracking, image search, human recognition, scene understanding, spatial understanding, and image enhancement. Also, inference/prediction technology may be configured to determine information and perform logical inference and prediction. Such inference and prediction technology may include, for example, knowledge-based inference, probability-based inference, optimization-based prediction, preference-based planning, recommendation processing.

Recently electronic apparatuses that perform various functions while moving in a specific space (e.g., a home, a restaurant, etc.) have been developed. For example, movable projector, robot cleaner, serving robot, guiding robot, and other similar electronic apparatuses are capable of performing various functions while moving in a specific space.

Such an electronic apparatus may recognize a current location by using various sensors. Further, when the electronic apparatus is lifted from a first location and placed in a second location, the electronic apparatus may re-recognize the current location by re-detecting the surrounding environment.

In a case where an electronic apparatus was lifted from a first location and placed in a second location, the electronic apparatus 100 merely detects the current second location, and cannot identify whether only the location was moved on the same floor, or the electronic apparatus was placed on furniture such as a table, or moved to another floor. Due to this, a problem that the electronic apparatus falls from the top of the furniture, or moves based on another map may occur.

### SUMMARY

According to an aspect of the disclosure, an electronic apparatus may include at least one sensor; a driver; memory storing at least one instruction; and one or more processors operatively connected to the at least one sensor, the driver, and the memory, wherein at least one instruction, when executed by the one or more processors individually or collectively, causes the electronic apparatus to: identify whether the electronic apparatus was lifted while the electronic apparatus is operating in a first driving state based on a first map of an area where the electronic apparatus is located; based on the electronic apparatus being lifted while the electronic apparatus is operating in the first driving state, obtain information about a height at which the electronic apparatus is placed after being lifted based on a sensing value obtained from the at least one sensor, and based on the height being within a first range, operate in a second driving state, wherein a speed of the electronic apparatus is limited to less than a first value in the second driving state.

The at least one instruction, when executed by the one or more processors individually or collectively, causes the electronic apparatus to: while the electronic apparatus is moving after being lifted, obtain first information about a location to which the electronic apparatus moved based on the sensing value obtained from the at least one sensor, and based on the electronic apparatus being placed, identify the location to which the electronic apparatus moved based on the obtained first information.

The at least one sensor may include an IMU sensor and a bottom surface detection sensor, and wherein the at least one instruction, when executed by the one or more processors individually or collectively, causes the electronic apparatus to: while operating in the second driving state, identify whether the first map for a space in which the electronic apparatus is placed is stored in the memory based on the first information about the location, and based on the first map being identified as not stored in the memory, generate a second map for the space based on sensing values obtained through the IMU sensor and the bottom surface detection sensor while the electronic apparatus is moving in the space.

The at least one instruction, when executed by the one or more processors individually or collectively, causes the electronic apparatus to: match information about the second map generated based on the first information about the location with the first map and store the information about the second map in the memory.

The at least one instruction, when executed by the one or more processors individually or collectively, causes the electronic apparatus to: while operating in the second driving state, control the driver to move at the speed less than the first value within the space based on information about the second map.

The electronic apparatus may further include a projection part including a short throw projector. The at least one instruction, when executed by the one or more processors individually or collectively, causes the electronic apparatus to: while operating in the second driving state, control the projection part to project a screen by using the short throw projector in the space.

The at least one instruction, when executed by the one or more processors individually or collectively, causes the electronic apparatus to: based on the height being within a second range higher than the first range, operate in a third driving state, wherein the electronic apparatus moves based on a third map corresponding to the height in the third driving state.

The at least one instruction, when executed by the one or more processors individually or collectively, causes the electronic apparatus to: identify whether information about the third map is stored in the memory; and based on the information about the third map being identified as not stored in the memory, generate the third map for a space in which the electronic apparatus is placed based on the sensing value obtained from the at least one sensor while the electronic apparatus is moving in the space.

The at least one instruction, when executed by the one or more processors individually or collectively, causes the electronic apparatus to: obtain information about a driving state according to the height by inputting the sensing value obtained from the at least one sensor into a trained neural network model.

According to an aspect of the disclosure, a control method for an electronic apparatus may be provided. The method may include operating in a first driving state, wherein the electronic apparatus moves based on a first map of an area where the electronic apparatus is located in the first driving state; identifying whether the electronic apparatus was lifted while the electronic apparatus is operating in the first driving state; based on identifying that the electronic apparatus was lifted while the electronic apparatus is operating in the first driving state, obtaining information about a height at which the electronic apparatus is placed after being lifted based on a sensing value obtained from at least one sensor; and based on the height being within a first range, operating in a second driving state, wherein a speed of the electronic apparatus is limited to less than a first value in the second driving state.

The method may further include while the electronic apparatus is moving after being lifted, obtaining first information about a location to which the electronic apparatus moved based on the sensing value obtained from the at least one sensor; and based on the electronic apparatus being placed, identifying the location to which the electronic apparatus moved based on the obtained first information.

The control method may further include while operating in the second driving state, identifying whether the first map for a space in which the electronic apparatus is placed is stored in a memory of the electronic apparatus based on the first information about the location; and based on identifying that the first map is not stored in the memory, generating a second map for the space based on sensing values obtained through the IMU sensor and the bottom surface detection sensor while the electronic apparatus is moving in the space.

The control method may further include matching information about the second map generated based on the first information about the location with the first map and storing the information about the second map in the memory.

The control method may further include, while operating in the second driving state, moving at the speed less than the first value within the space based on information about the second map.

The control method may further include, while operating in the second driving state, projecting a screen by using a short throw projector of the electronic apparatus in the space wherein the electronic apparatus is placed.

The control method may further include, based on the height being within a second range higher than the first range, operating in a third driving state, wherein the electronic apparatus moves based on a third map corresponding to the height in the third driving state.

The control method may further include: identifying whether information about the third map is stored in a memory of the electronic apparatus; and based on identifying that the information about the third map is not stored in the memory, generate the third map for a space in which the electronic apparatus is placed based on the sensing value obtained from the at least one sensor while the electronic apparatus is moving in the space.

The method may further include: inputting the sensing value obtained from the at least one sensor into a trained neural network; and obtaining information about a driving state according to the height based on the inputting the sensing value obtained from the at least one sensor into the trained neural network model.

The method may further include: identifying whether the height has changed; based on identifying that the height has changed, identifying whether the height is within the first range; and based on identifying that the height is not within the first range, operating in a third driving state, wherein the electronic apparatus moves based on a third map corresponding to the height in the third driving state.

According to an aspect of the disclosure, a non-transitory computer-readable medium storing instructions that, when executed by a processor of an electronic apparatus, cause the electronic apparatus to: operate in a first driving state, wherein the electronic apparatus moves based on a first map of an area in which the electronic apparatus is located in the first driving state; identify whether the electronic apparatus was lifted while the electronic apparatus is operating in the first driving state; based on identifying that the electronic apparatus was lifted while the electronic apparatus is operating in the first driving state, obtain information about a height at which the electronic apparatus is placed after being lifted based on a sensing value obtained from at least one sensor; and based on the height being within a first range, operate in a second driving state, wherein a speed of the electronic apparatus is limited to less than a first value in the second driving state.

### BRIEF DESCRIPTION OF THE DRAWINGS

FIG. 1 is a block diagram schematically illustrating a configuration of an electronic apparatus according to an embodiment of the disclosure;

FIG. 2 is a flow chart for illustrating a method of determining a driving state of an electronic apparatus according to an embodiment of the disclosure;

FIG. 3 is a flow chart for illustrating a method of controlling an operation of an electronic apparatus while operating in a second driving state according to an embodiment of the disclosure;

FIG. 4A and FIG. 4B are diagrams for illustrating a method of controlling an operation of an electronic apparatus while operating in a second driving state according to an embodiment of the disclosure;

FIG. 5 is a flow chart for illustrating a method of controlling an operation of an electronic apparatus while operating in a third driving state according to an embodiment of the disclosure;

FIG. 6 is a diagram for illustrating a first map and a third map according to an embodiment of the disclosure;

FIG. 7 is a flow chart for illustrating a method of determining a driving state of an electronic apparatus by using a trained neural network model according to an embodiment of the disclosure;

FIG. 8 is a diagram for illustrating a neural network model trained to determine a driving state of an electronic apparatus according to an embodiment of the disclosure;

FIG. 9 is a block diagram illustrating in detail a configuration of an electronic apparatus according to an embodiment of the disclosure; and

FIG. 10 is a perspective view illustrating the exterior of an electronic apparatus according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Further, in case it is determined that in describing the disclosure, detailed explanation of related known functions or components may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Also, the expressions “first,” “second,” and the like used in the disclosure may describe various elements regardless of any order and/or degree of importance. In addition, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, in the embodiments of the disclosure, ‘a module’ or ‘a unit’ may perform at least one function or operation, and may be implemented as hardware or software, or as a combination of hardware and software. Further, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

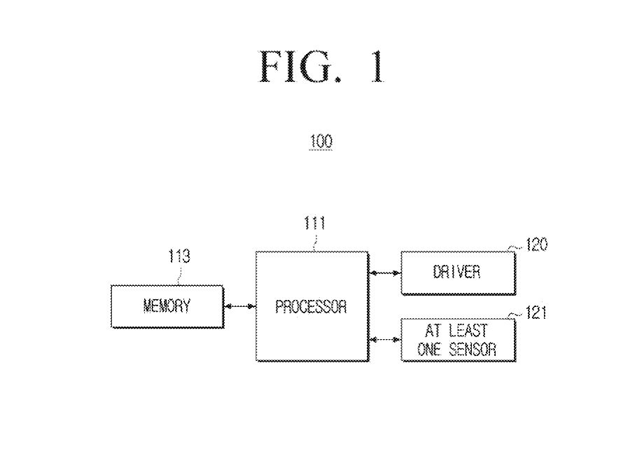

FIG. 1 is a block diagram schematically illustrating a configuration of an electronic apparatus according to an embodiment of the disclosure. As illustrated in FIG. 1, an electronic apparatus 100 includes memory 113, a driver 120, at least one sensor 121, and a processor 111. Meanwhile, the components illustrated in FIG. 1 are merely one of various embodiments, and some components may be omitted, and new components may be added. Meanwhile, the electronic apparatus 100 according to an embodiment of the disclosure may be a movable projector that projects images, but is not limited thereto, and it may be implemented as various electronic apparatuses such as a robot cleaner, a serving robot, a guiding robot, etc.

The memory 113 may store an operating system (OS) for controlling the overall operations of the components of the electronic apparatus 100, and instructions or data related to the component of the electronic apparatus 100. In particular, the memory 113 may include a plurality of modules for the electronic apparatus 100 to operate in different driving states (or driving modes) according to the height (of a space) in which the electronic apparatus 100 is placed after being lifted. In particular, when a function for the electronic apparatus 100 to operate in different driving states according to the height at which the electronic apparatus 100 is placed after the power of the electronic apparatus 100 is turned on or the electronic apparatus 100 is lifted is executed, the electronic apparatus 100 may load data for the various modules stored in non-volatile memory to perform various types of operations on volatile memory. Here, loading means an operation of calling in data stored in the non-volatile memory to the volatile memory and storing the data, so that the processor 111 can access the data.

In particular, the memory 113 may store information about a map of an area in which the electronic apparatus 100 is located (e.g., a house, a restaurant, an airport, etc.). Here, the map may include a picture that reduced a state of an indoor space (or an object space) by a specific ratio, and expressed it on a plane. According to the embodiments of the disclosure, the map may include a picture that reduced the plane structure of the area in which the electronic apparatus 100 is located by a specific ratio, and expressed it with a pre-arranged symbol. For example, the map may include a picture that expresses the plane structure with lines. However, the disclosure is not limited thereto, and the map may include a location of a main object within the area. Also, the map may be a two-dimensional map, but this is merely an example, and it may be a three-dimensional map.

According to the embodiments of the disclosure, the memory 113 may store information about a plurality of maps of an area. The plurality of maps may be mapped with the height at which the electronic apparatus 100 is placed and stored. For example, the plurality of maps may include a map for the space of the first floor, a map for the space of the second floor, a map for the space of furniture (e.g., a table) included in the area in which the electronic apparatus 100 is located, etc. Here, in the map, information about objects arranged within the space may be included.

Also, the memory 113 may store data about various neural network models. For example, the memory 113 may store a neural network model for determining a driving state by inputting a sensing value obtained from the at least one sensor 121. As another example, the memory 113 may store a neural network model for detecting lifting of the electronic apparatus 100 by inputting a sensing value obtained from the at least one sensor 121. However, this is merely an example, and a trained neural network model can obviously be stored in an external device (e.g., an external server, etc.).

The driver 120 may generate physical force and transmit the force to the driving unit (e.g., a wheel) included in the electronic apparatus 100. In particular, the driver 120 may move to a target location by control by the processor 110. In particular, the driver 120 may control moving of the electronic apparatus 100 to limited speed according to a driving state. For example, in the case of operating in a second driving state (e.g., a case in which the electronic apparatus 100 is placed on a table), the driver 120 may move the electronic apparatus 100 while limiting the speed of the electronic apparatus 100 to smaller than a first value.

The at least one sensor 121 may obtain various types of information about the state of the electronic apparatus 100 or the ambient environment of the electronic apparatus 100. In particular, the at least one sensor 121 may include an inertial measurement unit (IMU) sensor. The IMU sensor is a sensor for detecting a movement of the electronic apparatus 100, and may be implemented as a six-axis sensor or a nine-axis sensor. Here, the IMU sensor may include at least one of a geomagnetic sensor, an acceleration sensor, or a gyro sensor. Also, the at least one sensor 121 may include a Time of Flight (ToF) sensor. A LiDAR sensor may project a ray onto an object and detect a light reflected by the object, and obtain a sensing value for obtaining information about a distance from the object. However, as described above, the feature of using a LiDAR sensor for obtaining information about a distance from an object is merely an example, and information about a distance from an object may be obtained by using various sensors such as a depth sensor. In particular, the processor 111 may generate a map for an indoor space based on sensing values (or sensing information) obtained through the IMU sensor and the LiDAR sensor. Also, the at least one sensor 121 may include a bottom surface detection sensor for preventing fall of the electronic apparatus 100 as a distance measurement sensor toward the bottom surface (e.g., a ToF sensor, etc.). Further, the at least one sensor 121 may include a sensor that is provided on a wheel, etc. of the electronic apparatus 100 and is for detecting lifting of the electronic apparatus 100.

The processor 111 may control the electronic apparatus 100 according to at least one instruction stored in the memory 113.

In particular, the processor 111 may include one or more processors. Specifically, the one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor may control one or a random combination of the other components of the electronic apparatus 100, and perform an operation related to communication or data processing. Also, the at least one processor may execute one or more programs or instructions stored in the memory. For example, the at least one processor may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. In other words, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor). For example, the electronic apparatus 100 may perform an operation of generating a map or an operation of controlling driving of the electronic apparatus 100, etc. by using a generic-purpose processor, and perform an operation of determining a driving state of the electronic apparatus 100 through a neural network model by using an artificial intelligence-dedicated processor.

The at least one processor may be implemented as a single core processor including one core, or it may be implemented as one or more multicore processors including a plurality of cores (e.g., multicores of the same kind or multicores of different kinds). In case the at least one processor is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

According to one or more embodiments of the disclosure, the processor 111, by executing the at least one instruction stored in the memory 113, if lifting of the electronic apparatus 100 is detected while operating in a first driving state in which the electronic apparatus 100 moves based on a first map of the area in which the electronic apparatus 100 is located, obtains information about a height at which the electronic apparatus 100 is placed after being lifted based on a sensing value obtained from the at least one sensor 121. If the height at which the electronic apparatus 100 is placed after being lifted is within a predetermined first range, the processor 111 operates in a second driving state in which the speed of the electronic apparatus 100 is limited to less than a first value.

According to an embodiment, while the electronic apparatus 100 is moving after being lifted, the processor 111 may obtain first information about a location to which the electronic apparatus 100 moved based on a sensing value obtained from the at least one sensor 121. When the electronic apparatus 100 is placed, the processor 111 may identify the location to which the electronic apparatus 100 moved based on the first information.

According to an embodiment, if the processor 111 operates in the second driving state, the processor 111 may identify whether a map for the space in which the electronic apparatus 100 is placed is stored based on the information about the location to which the electronic apparatus 100 moved. If the information about the map is not stored, the processor 111 may generate a second map for the space in which the electronic apparatus 100 is placed based on sensing values obtained through the IMU sensor and the bottom surface detection sensor while the electronic apparatus 100 is moving in the space in which it is placed after being placed.

According to an embodiment, the processor 111 may match information about the second map generated based on the information about the location to which the electronic apparatus 100 moved with the first map and store the information.

According to an embodiment, while operating in the second driving state, the processor 111 may control the driver 120 to move at speed smaller than the first value only within the space in which the electronic apparatus 100 is placed based on the information about the second map.

According to an embodiment, while operating in the second driving state, the processor 111 may project a screen by using a short throw projector in the space in which the electronic apparatus 100 is placed.

According to an embodiment, if the height at which the electronic apparatus 100 is placed after being lifted is within a second range higher than the first range, the processor 111 may identify a third map corresponding to the height at which the electronic apparatus 100 is placed after being lifted among a plurality of maps of the area stored by the electronic apparatus 100. The electronic apparatus 100 may operate in a third driving state in which the electronic apparatus 100 moves based on the third map.

According to an embodiment, if it is identified that information about the third map among the plurality of maps of the area is not stored, the processor 111 may generate the third map for the space in which the electronic apparatus 100 is placed based on a sensing value that was obtained while the electronic apparatus 100 is moving in the space in which it is placed.

According to an embodiment, the processor 111 may obtain information about a driving state according to the height at which the electronic apparatus 100 is placed after being lifted by inputting a sensing value obtained from the at least one sensor 121 into a trained neural network model.

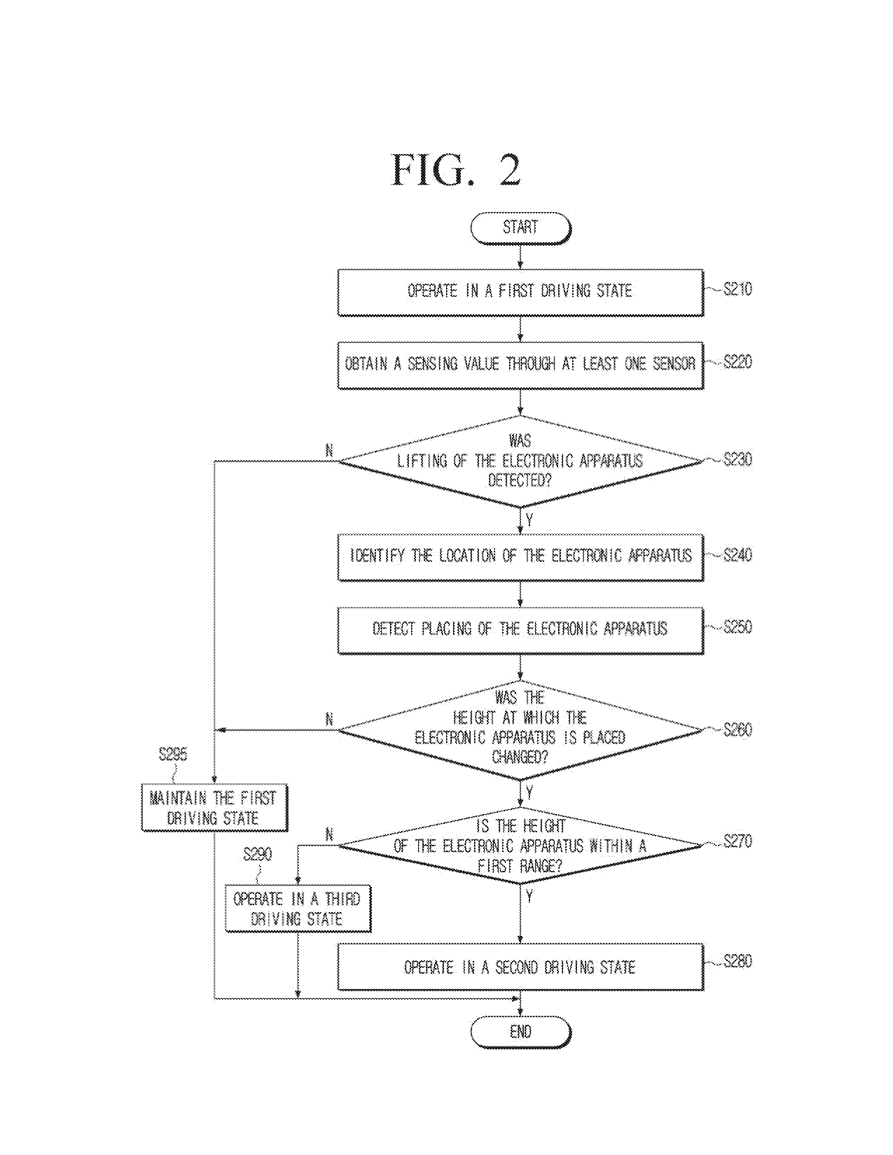

Hereinafter, the disclosure will be described in more detail with reference to the drawings. FIG. 2 is a flow chart for illustrating a method of determining a driving state of an electronic apparatus according to an embodiment of the disclosure.

First, the electronic apparatus 100 may operate in the first driving state in the step S210. Here, the first driving state is a state of driving in an indoor space based on the first map. The electronic apparatus 100 may drive in an indoor space corresponding to the first map without limitation on the speed while driving in the first driving state.

The electronic apparatus 100 may obtain a sensing value through the at least one sensor 121 in the step S220. For example, while operating in the first driving state, the electronic apparatus 100 may obtain a sensing value through the nine-axis IMU sensor, and obtain a sensing value through the LiDAR sensor, and obtain a sensing value through the sensor for detecting lifting, but this is merely an example, and the electronic apparatus 100 may obtain an image through a camera.

The electronic apparatus 100 may identify whether lifting of the electronic apparatus 100 was detected in the step S230. Here, lifting of the electronic apparatus 100 may mean that the electronic apparatus 100 (or a wheel of the electronic apparatus 100) is detached from the bottom surface of an indoor space wherein the electronic apparatus 100 moves. Specifically, the electronic apparatus 100 may identify whether lifting of the electronic apparatus 100 was detected based on the sensing value obtained in the step S220. According to an embodiment, the electronic apparatus 100 may identify whether lifting of the electronic apparatus 100 was detected based on the sensing value obtained in the step S220 or a change of an image. According to an embodiment, the electronic apparatus 100 may identify whether lifting of the electronic apparatus 100 was detected by inputting the sensing value obtained in the step S220 into a trained neural network model (e.g., a lifting detection model).

If it is identified that lifting of the electronic apparatus 100 is not detected in the step S230-N, the electronic apparatus 100 may maintain the first driving state in the step S295.

If it is identified that lifting of the electronic apparatus 100 was detected in the step S230-Y, the electronic apparatus 100 may identify (or assume) the location of the electronic apparatus 100 in the step S240. Specifically, if moving of the electronic apparatus 100 is detected after lifting is detected, the electronic apparatus 100 may identify the location of the electronic apparatus 100 through dead reckoning navigation. In other words, the electronic apparatus 100 may obtain a moving direction and moving speed of the electronic apparatus 100 based on a sensing value obtained from the at least one sensor 121, and assume the location to which the electronic apparatus 100 moved from the starting location wherein lifting of the electronic apparatus 100 was detected based on the obtained moving direction and moving speed. Here, the electronic apparatus 100 may obtain information about not only the locations to which the electronic apparatus 100 moved on the X and Y axes on the first map, but also the location to which the electronic apparatus 100 moved on the Z axis (the height).

The electronic apparatus 100 may detect placing of the electronic apparatus 100 in the step S250. Here, the placing of the electronic apparatus 100 may mean that the electronic apparatus 100 (or, the wheel of the electronic apparatus 100) contacts the bottom surface of a specific space. According to an embodiment, if it is identified that a sensing value obtained from the at least one sensor 121 is not changed during a threshold time, the electronic apparatus 100 may detect placing of the electronic apparatus 100. According to an embodiment, the electronic apparatus 100 may detect placing of the electronic apparatus 100 by inputting a sensing value obtained from the at least one sensor 121 into the trained neural network model.

The electronic apparatus 100 may identify whether the height at which the electronic apparatus 100 is placed was changed in the step S260. Here, the electronic apparatus 100 may identify whether the height at which the electronic apparatus 100 is placed was changed based on a sensing value that was obtained after lifting of the electronic apparatus 100. According to an embodiment, the electronic apparatus 100 may identify whether the height at which the electronic apparatus 100 is placed was changed by inputting a sensing value that was obtained after lifting of the electronic apparatus 100 into the trained neural network model.

If it is identified that the height at which the electronic apparatus 100 is placed is not changed in the step S260-N, the electronic apparatus 100 may maintain the first driving state in the step S295. In other words, if it is identified that the electronic apparatus 100 is placed in the same space as the previous space, the electronic apparatus 100 may move in the indoor space while maintaining the first driving state which is the previous driving state. According to an embodiment, if a change of the height smaller than a threshold value (e.g., 1cm) is detected, the electronic apparatus 100 may identify that the height at which the electronic apparatus 100 is placed is not changed.

If it is identified that the height at which the electronic apparatus 100 is placed is changed in the step S260-Y, the electronic apparatus 100 may identify whether the height at which the electronic apparatus 100 is placed is within a first range in the step S270. Here, the first range is a range wherein the floor of the space wherein the electronic apparatus 100 moves is not changed, and it may be, for example, 1m or bigger and smaller than 2m, but is not limited thereto.

If it is identified that the height is within the first range in the step S270-Y, the electronic apparatus 100 may operate in the second driving state in the step S280. Here, the second driving state may be a state wherein the electronic apparatus 100 drives in the space wherein it is located (in particular, furniture such as a table and a desk) at limited speed smaller than the first value (e.g., the speed value in the previous first driving state). Here, the second driving state may be referred to as a table driving state, etc. Here, the electronic apparatus 100 may drive at limited speed based on a second map (or, a mini map) corresponding to the space wherein the electronic apparatus 100 is located (e.g., a table) while operating in the second driving state. The electronic apparatus 100 may limit the moving range based on sensing values obtained through the bottom surface detection sensor and the IMU sensor while operating in the second driving state. Here, the electronic apparatus 100 may determine a projection surface for projecting a screen together with the limited moving range by using at least one of the IMU sensor, the LiDAR sensor, or the camera.

If it is identified that the height is outside the first range in the step S270-N, the electronic apparatus 100 may operate in a third driving state. Here, the third driving state is a state of driving in the indoor space based on the second map different from the first map. The electronic apparatus 100 may drive in the indoor space corresponding to the second map without limitation on the speed while driving in the third driving state. In other words, if it is identified that the height at which the electronic apparatus 100 is placed after being lifted is within a second range (e.g., 2m or bigger and smaller than 3m) higher than the first range, the electronic apparatus 100 may identify that the floor on which the electronic apparatus 100 is located was changed, and move based on the second map corresponding to the floor on which the electronic apparatus 100 is located. Meanwhile, the first range and the second range may be set differently according to the floor height of the house wherein the electronic apparatus 100 is located or a user input.

Meanwhile, in the aforementioned embodiment, it was explained that, in case the house wherein the electronic apparatus 100 is located has two stories, the electronic apparatus 100 operates in the first to third driving states. However, this is merely an example, and in case the house wherein the electronic apparatus 100 is located has three or more stories, the number of the driving states may be changed to correspond to the number of the stories of the house wherein the electronic apparatus 100 is located. For example, in case the house wherein the electronic apparatus 100 is located has three stories, the electronic apparatus 100 may operate in the first to fourth driving states.

Also, in the aforementioned embodiment, it was explained that the driving state is the second driving state regardless of the type of the furniture on which the electronic apparatus 100 is placed. However, this is merely an example, and a plurality of second driving states may be included according to the type (or the height) of the furniture on which the electronic apparatus 100 is placed. For example, in case the electronic apparatus 100 is placed on a table, the electronic apparatus 100 may operate in a 2-1 driving state (or a first table driving state), and in case the electronic apparatus 100 is placed on a desk, the electronic apparatus 100 may operate in a 2-2 driving state (or a second table driving state). Here, in case the driving states are divided according to the type (or the height) of the furniture on which the electronic apparatus 100 is placed, the electronic apparatus 100 may project a screen on the projection surface by controlling the projection part by different settings according to the divided driving states.

Also, in the aforementioned embodiment, the electronic apparatus 100 obtained information about lifting of the electronic apparatus 100 and the height at which the electronic apparatus 100 is placed by using a sensing value obtained through the nine-axis IMU sensor. However, this is merely an example, and the electronic apparatus 100 may obtain information about lifting of the electronic apparatus 100 and the height of the space wherein the electronic apparatus 100 is placed by using a sensing value obtained through the ToF sensor or an image photographed through the camera.

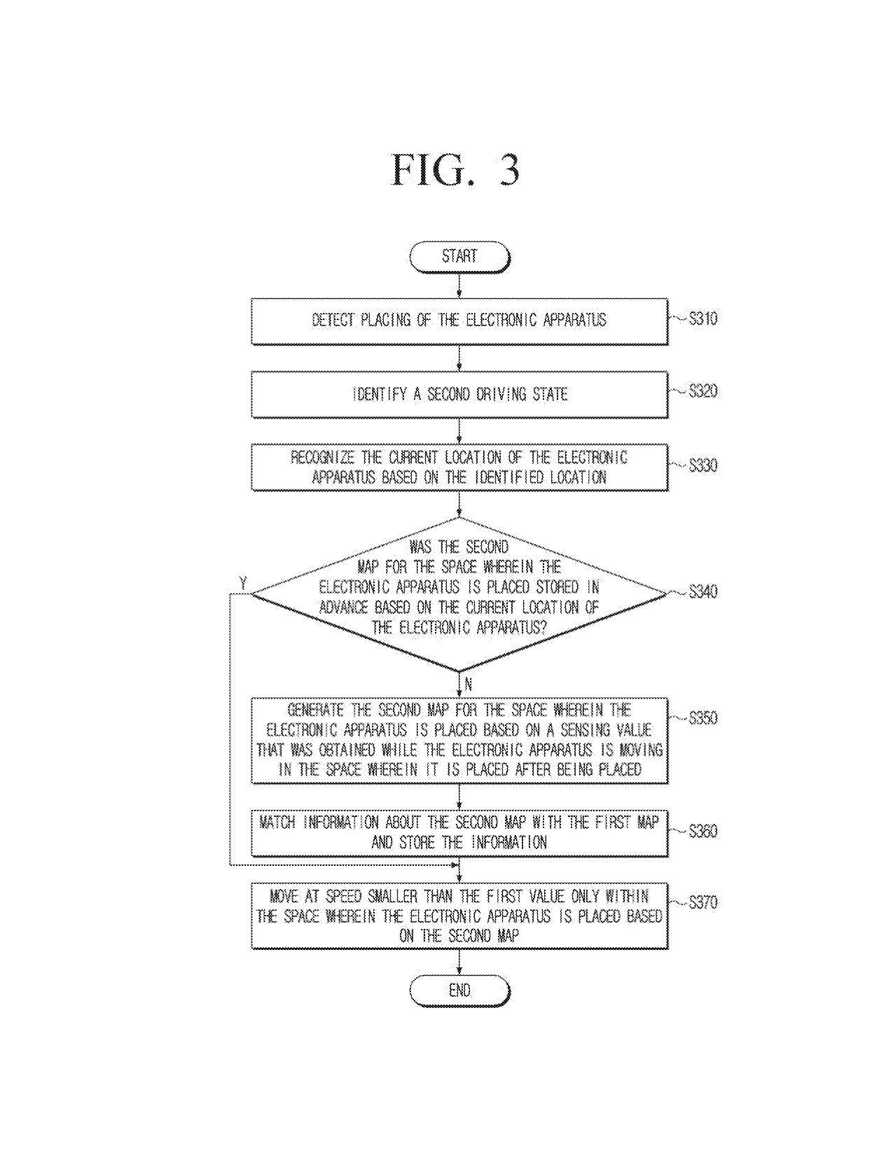

FIG. 3 is a flow chart for illustrating a method of controlling an operation of an electronic apparatus while operating in a second driving state according to an embodiment of the disclosure.

The electronic apparatus 100 may detect placing of the electronic apparatus 100 in the step S310. Specifically, if it is detected that a sensing value obtained from the at least one sensor 121 after the electronic apparatus 100 was lifted is not changed during a threshold time, the electronic apparatus 100 may detect placing of the electronic apparatus 100. Alternatively, the electronic apparatus 100 may detect that the electronic apparatus 100 is placed after being lifted by inputting a sensing value obtained from the at least one sensor 121 into the trained neural network model.

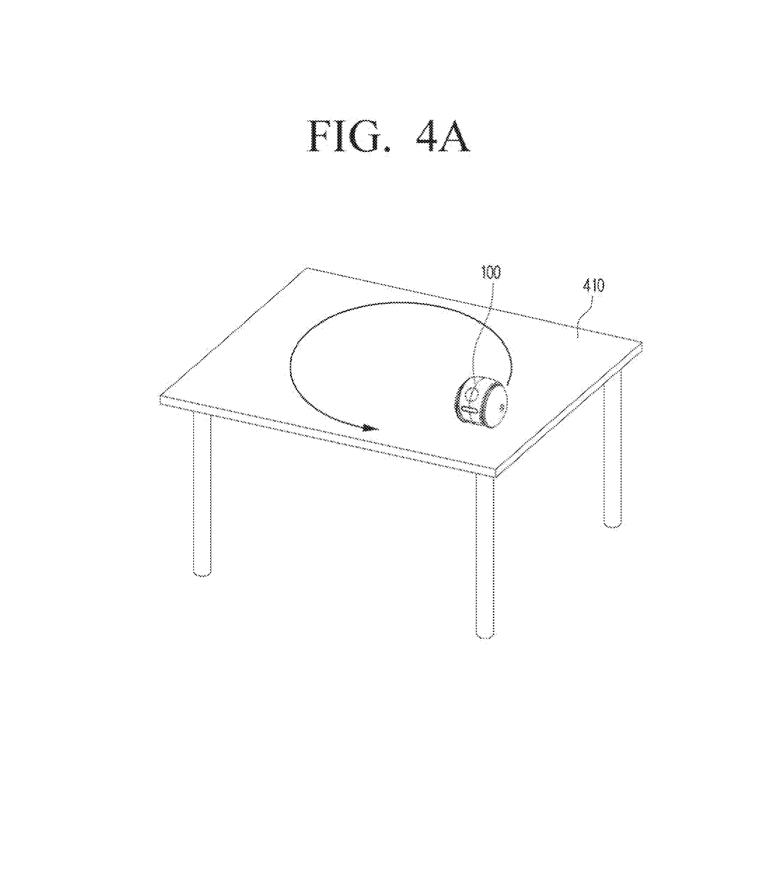

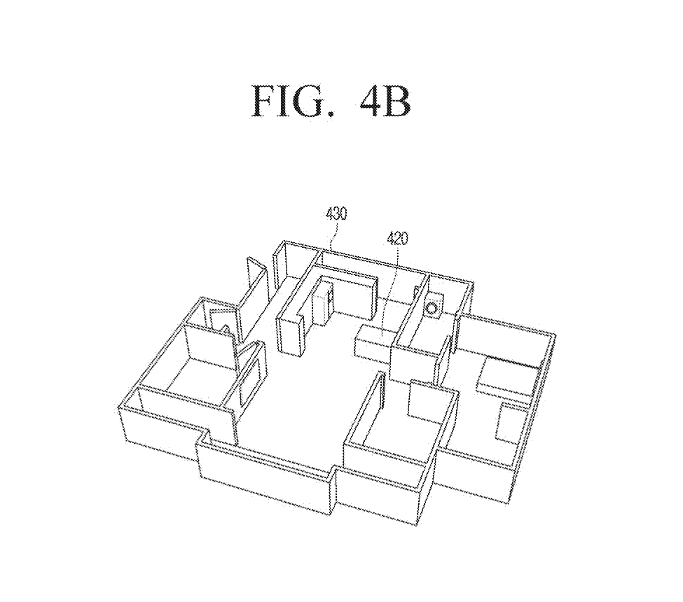

Here, as illustrated in FIG. 4A, the electronic apparatus 100 may be placed on the table 410 after it was lifted.

The electronic apparatus 100 may detect operating in the second driving state in the step S320. Specifically, as explained in FIG. 2, if it is identified that the height of the space wherein the electronic apparatus 100 is placed is within the first range, the electronic apparatus 100 may identify that the electronic apparatus 100 operates in the second driving state wherein it drives at limited speed smaller than the first value in the space wherein it is located.

The electronic apparatus 100 may recognize the current location of the electronic apparatus 100 based on an identified location in the step S330. Specifically, the electronic apparatus 100 may recognize the location to which the electronic apparatus 100 moved through dead reckoning navigation as explained in the step S240 in FIG. 2 after being lifted. Then, when placing of the electronic apparatus 100 is detected, the electronic apparatus 100 may re-recognize the current location based on an image obtained through the camera or a sensing value obtained through the at least one sensor 121 based on the identified location.

The electronic apparatus 100 may identify whether the second map for the space wherein the electronic apparatus 100 is placed was stored in advance based on the current location of the electronic apparatus 100 in the step S340. Specifically, in the first map for the electronic apparatus 100 to move, at least one second map about at least one object (e.g., a desk, a table, a dining table, etc.) included in the first map may be stored. The electronic apparatus 100 may identify an object corresponding to the current location based on the recognized current location of the electronic apparatus 100. The electronic apparatus 100 may identify whether the second map for the space wherein the electronic apparatus 100 is placed was stored in advance based on whether the second map corresponding to the identified object was stored. For example, in case the current location of the electronic apparatus 100 is (x1, y1) of the living room, the electronic apparatus 100 may identify whether an object is located on (x1, y1) of the living room, and if it is identified that an object is located, the electronic apparatus 100 may identify whether the second map for the space wherein the electronic apparatus 100 is placed was stored in advance by identifying whether the second map corresponding to the object located on (x1, y1) of the living room was stored.

If it is identified that the second map for the space wherein the electronic apparatus 100 is placed was stored in advance in the step S340-Y, the electronic apparatus 100 may move at speed smaller than the first value only within the space wherein the electronic apparatus 100 is placed based on the identified second map in the step S370. In other words, the electronic apparatus 100 may move at speed within a limited range only on the table 410 based on the identified second map.

If it is identified that the second map for the space wherein the electronic apparatus 100 is placed was not stored in advance in the step S340-N, the electronic apparatus 100 may generate the second map for the space wherein the electronic apparatus 100 is placed based on a sensing value that was obtained while the electronic apparatus 100 was moving in the space wherein it is placed after being placed in the step S350. In other words, while the electronic apparatus 100 is moving in the space wherein it is placed, in case the bottom is located lower than the electronic apparatus 100 or an obstacle is located based on sensing values obtained through the IMU sensor and the bottom surface detection sensor, the electronic apparatus 100 may determine the area as an area wherein moving is impossible, and obtain information about the boundary surface. Then, the electronic apparatus 100 may obtain information about the size of the space wherein the electronic apparatus 100 is placed (i.e., the table 410), its shape, and a movable range based on the information about the boundary surface. Then, the electronic apparatus 100 may generate the second map for the space wherein the electronic apparatus 100 is placed based on the information about the size of the space wherein the electronic apparatus 100 is placed, its shape, and the movable range. Here, the second map may be referred to as a table map or a mini map.

The electronic apparatus 100 may match information about the second map with the first map and store the information in the step S360. Specifically, the electronic apparatus 100 may identify information about the location to which the electronic apparatus 100 moved within the first map based on a sensing value that was obtained while the electronic apparatus 100 was moving in the space wherein it was placed. The electronic apparatus 100 may match the information about the second map with the first map and store the information based on the information about the location to which the electronic apparatus 100 moved. For example, in case the information about the location to which the electronic apparatus 100 moved is within a first area of the kitchen on the first map, as illustrated in FIG. 4B, the electronic apparatus 100 may store the second map 420 related to the table 410 in the first area of the kitchen on the first map 430. Here, the electronic apparatus 100 may identify information about the type of the space wherein the electronic apparatus 100 is placed (e.g., a table), and store the information on the first map 430 together with the second map 420. Meanwhile, in FIG. 4B, it was explained that the first map 430 is a three-dimensional map, but this is merely an example, and it can obviously be implemented as a two-dimensional map.

The electronic apparatus 100 may move at speed smaller than the first value only within the space wherein the electronic apparatus 100 is placed based on the generated second map in the step S370. In other words, the electronic apparatus 100 may move at speed within a limited range only on the table 410 based on the identified second map.

While the electronic apparatus 100 is operating in the second driving state, the electronic apparatus 100 may project a screen by using a short throw projector in the space wherein the electronic apparatus 100 is placed. In other words, in case the space wherein the electronic apparatus 100 is placed (i.e., the table 410) is located within a predetermined value from the projection surface, for projecting a screen in a close location, the electronic apparatus 100 may project a screen by using a short throw projector in the space wherein the electronic apparatus 100 is placed. However, in case the space wherein the electronic apparatus 100 is placed (i.e., the table 410) is located in a place that is beyond the predetermined value from the projection surface, the electronic apparatus 100 may project a screen by using a general projector in the space wherein the electronic apparatus 100 is placed.

Meanwhile, it was explained that the electronic apparatus 100 generates the second map for the space wherein the electronic apparatus 100 is placed and stores it in the first map, but this is merely an example, and the electronic apparatus 100 can obviously store only information about the size and the location of the space wherein it is placed in the first map.

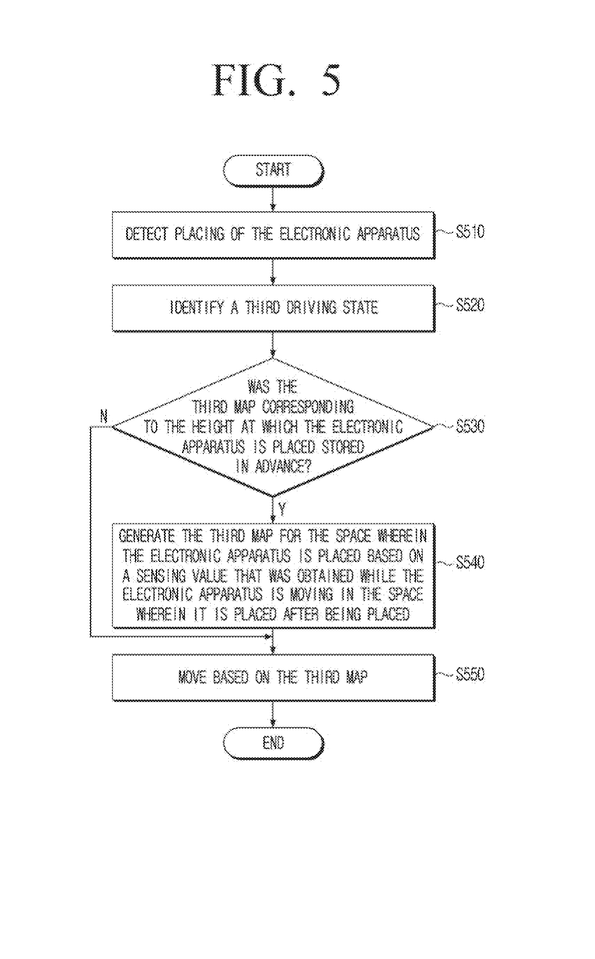

FIG. 5 is a flow chart for illustrating a method of controlling an operation of an electronic apparatus while operating in a third driving state according to an embodiment of the disclosure.

The electronic apparatus 100 may detect placing of the electronic apparatus 100 in the step S510. Here, the electronic apparatus 100 may be placed on another floor (e.g., a floor higher than the floor on which the electronic apparatus 100 operates in the first driving state) after being lifted.

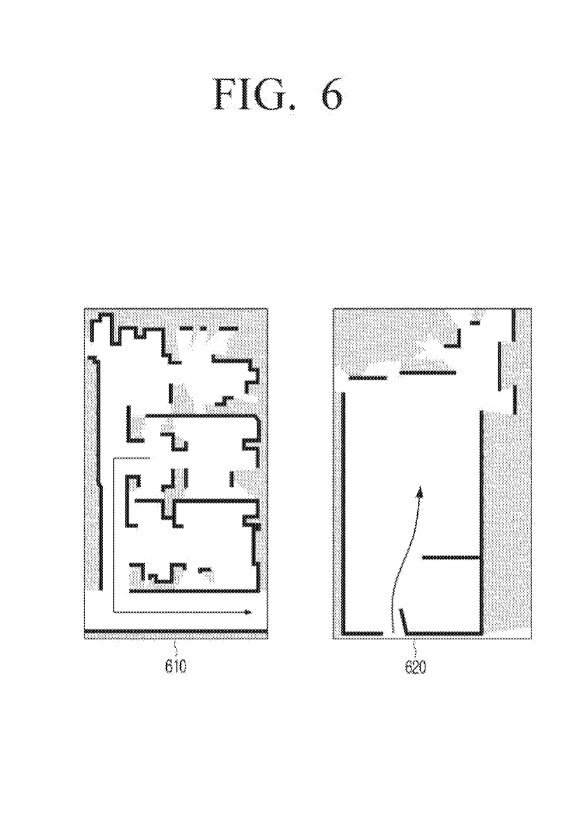

The electronic apparatus 100 may identify that the electronic apparatus 100 operates in the third driving state in the step S520. Specifically, as explained in FIG. 2, if it is identified that the height of the space wherein the electronic apparatus 100 is placed is within the second range bigger than the first range, the electronic apparatus 100 may identify that the electronic apparatus 100 operates in the third driving state wherein the electronic apparatus 100 moves based on a third map different from the first map. For example, as illustrated on the left side of FIG. 6, if it is identified that the electronic apparatus 100 was operating in the first driving state wherein it moves based on the first map 610 corresponding to the first floor and was then placed on the second floor, as illustrated on the right side of FIG. 6, the electronic apparatus 100 may identify that the electronic apparatus 100 operates in the third driving state wherein it moves based on the third map 620 corresponding to the second floor.

The electronic apparatus 100 may identify whether the third map corresponding to the height of the space wherein the electronic apparatus 100 is placed was stored in advance in the step S530. Specifically, the electronic apparatus 100 may store maps corresponding to each of the plurality of floors included in the house wherein the electronic apparatus 100 is located. The electronic apparatus 100 may identify the number of the floor of the space wherein the electronic apparatus 100 is placed based on the height of the space wherein it is placed. The electronic apparatus 100 may identify whether the third map corresponding to the number of the floor of the space in which the electronic apparatus 100 is placed was stored in advance. For example, in case the number of the floor of the space wherein the electronic apparatus 100 that previously operated on the first floor is placed after being lifted is the second floor, the electronic apparatus 100 may identify whether the third map corresponding to the second map was stored in advance.

If it is identified that the third map corresponding to the height of the space wherein the electronic apparatus 100 is placed was stored in advance in the step S530-Y, the electronic apparatus 100 may move based on the identified third map in the step S550. In other words, the electronic apparatus 100 may move based on the third map corresponding to the number of the floor on which the electronic apparatus 100 is located. For example, the electronic apparatus 100 may move based on the third map corresponding to the second floor which is the number of the floor on which the electronic apparatus 100 is located.

If it is identified that the third map corresponding to the height of the space wherein the electronic apparatus 100 is placed was not stored in advance in the step S530-N, the electronic apparatus 100 may generate the third map for the space wherein the electronic apparatus 100 is placed based on a sensing value that was obtained while the electronic apparatus 100 was moving in the space wherein it was placed after being placed in the step S540. Specifically, the electronic apparatus 100 may generate the third map for the space wherein the electronic apparatus 100 is placed based on a sensing value that was obtained through the at least one sensor 121 while the electronic apparatus 100 was moving in the space wherein it was placed. Here, if a user command for generating the third map is input, the electronic apparatus 100 may generate the third map for the space wherein the electronic apparatus 100 is placed based on a sensing value that was obtained through the at least one sensor 121 while the electronic apparatus 100 was moving in the space wherein it was placed.

The electronic apparatus 100 may move based on the generated third map in the step S550. In other words, the electronic apparatus 100 may move based on the third map that corresponds to the number of the floor on which the electronic apparatus 100 is located and that was newly generated.

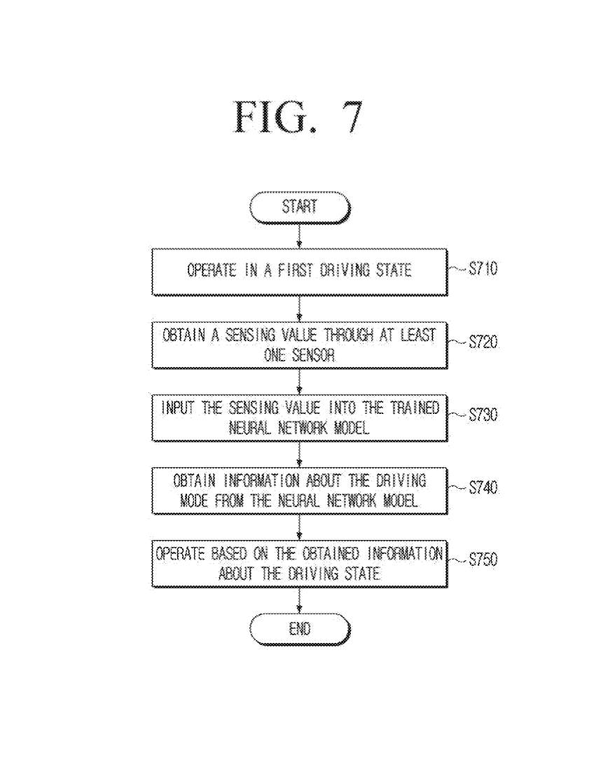

Meanwhile, in the aforementioned embodiment, it was explained that a driving state is determined based on the height of the space in which the electronic apparatus 100 is placed, but this is merely an example, and a driving state of the electronic apparatus 100 can be determined by using the trained neural network model. Hereinafter, a method of determining a driving state of the electronic apparatus 100 by using the trained neural network model will be explained with reference to FIG. 7.

First, the electronic apparatus 100 may operate in the first driving state in the step S710. The first driving state is a state of driving in an indoor space based on the first map. The electronic apparatus 100 may drive in the indoor space corresponding to the first map without a limitation on the speed while driving in the first driving state.

The electronic apparatus 100 may obtain a sensing value through the at least one sensor 121 in the step S720. According to an embodiment, while operating in the first driving state, the electronic apparatus 100 may obtain a sensing value through the nine-axis IMU sensor, and obtain a sensing value through the LiDAR sensor, and obtain a sensing value through the sensor for detecting lifting of the electronic apparatus 100. According to another embodiment, the electronic apparatus 100 may obtain an image through the camera.

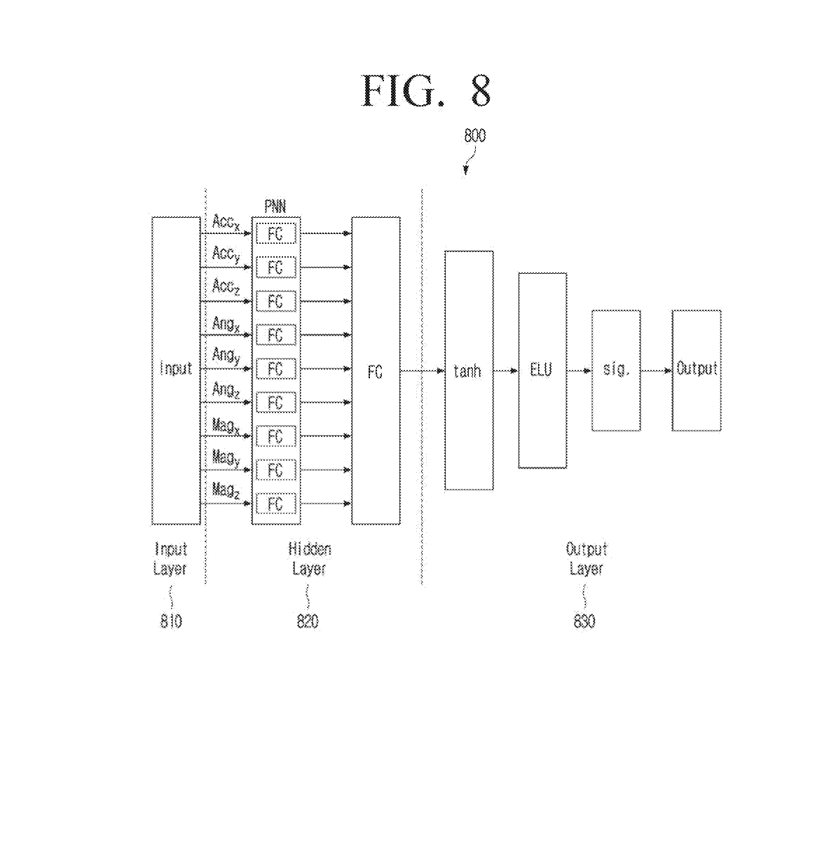

The electronic apparatus 100 may input the sensing value into the trained neural network model in the step S730. Here, the neural network model may be a model that was trained to determine a driving state corresponding to the height at which the electronic apparatus 100 is located by inputting a sensing value obtained through the at least one sensor 121 or a camera. According to an embodiment, as illustrated in FIG. 8, the neural network model 800 may include an input layer 810, a hidden layer 820, and an output layer 830. Here, the input layer 810 may receive inputs of sensing values of an acceleration sensor (Acc), an angular velocity sensor (Ang), and a geomagnetic sensor (Mag) respectively as information of x, y, and z axes, and transmit them to a parallel neural network model in parallel. Here, as sensing values obtained from the plurality of sensors, not only sensing values for one time axis but also sensing values according to continuous time may be transmitted to the parallel neural network model, and accuracy of classification can thereby be improved. The hidden layer 820 may put together median feature values obtained through neurons that were trained in parallel for each sensing value into one feature value, and transmit it to the output layer 830 for deriving a result value (or a final feature value). Through this, the neural network model can be made to learn the parts wherein each sensing value contributes to the result value individually. The output layer 830 is a step of reducing the number of neurons for deriving one result value (information about a driving state), and each activation function can be applied variously.

The electronic apparatus 100 may obtain information about the driving state from the neural network model in the step S740. For example, the electronic apparatus 100 may identify information about the driving state corresponding to the space wherein the electronic apparatus 100 is placed by inputting the sensing value that was obtained while the electronic apparatus 100 was moving after being lifted into the neural network model. For example, in case the electronic apparatus 100 is placed on the bottom surface of the previous floor, the electronic apparatus 100 may identify information about the first driving state through the neural network model, and in case the electronic apparatus 100 is placed on furniture (e.g., a table) on the previous floor, the electronic apparatus 100 may identify information about the second driving state through the neural network model. In case the electronic apparatus 100 is placed on the bottom surface of a new floor, the electronic apparatus 100 may identify information about the third driving state through the neural network model.

The electronic apparatus 100 may operate (or move) based on the obtained information about the driving state in the step S750. In other words, in the case of operating in the first driving state, the electronic apparatus 100 may move without limited speed based on the first map, and in the case of operating in the second driving state, the electronic apparatus 100 may move at limited speed based on the second map (or a table map), and in the case of operating in the third driving state, the electronic apparatus 100 may move without limited speed based on the third map.

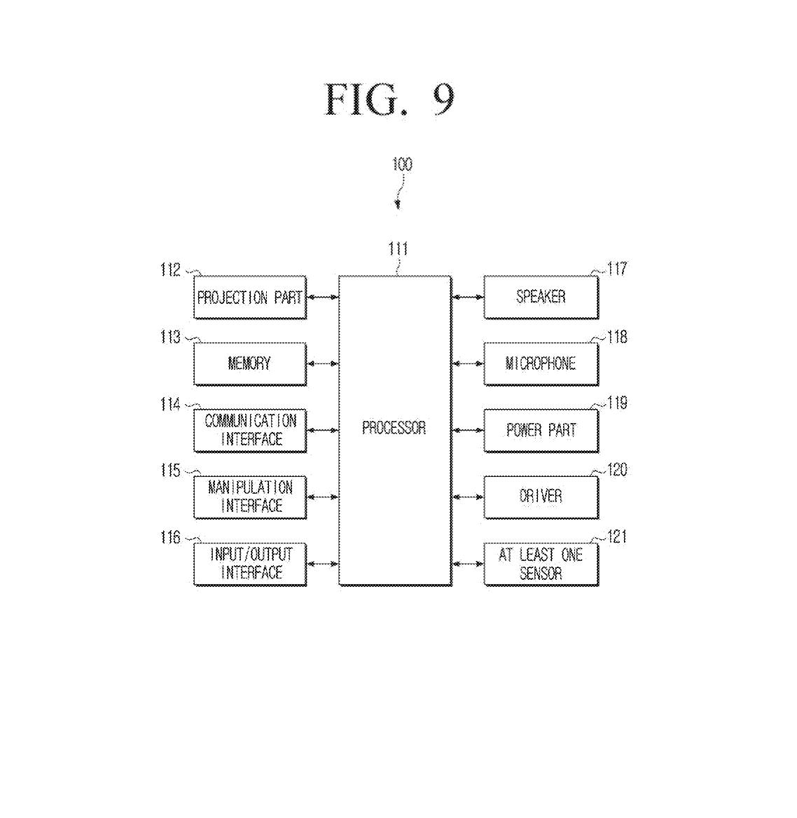

FIG. 9 is a block diagram illustrating in detail a configuration of an electronic apparatus according to an embodiment of the disclosure. Referring to FIG. 9, the electronic apparatus 100 may include at least one of a processor 111, a projection part 112, memory 113, a communication interface 114, a manipulation interface 115, an input/output interface 116, a speaker 117, a microphone 118, a power part 119, a driver 120, or a sensor 121. Meanwhile, the components illustrated in FIG. 9 are merely one of various examples, and some components may be omitted, or new components may be added. Meanwhile, the content that was already explained in FIG. 1 will be omitted.

The projection part 112 is a component that projects an image to the outside. The projection part 112 according to the various embodiments of the disclosure may be implemented by various projection methods (e.g., a cathode-ray tube (CRT) method, a liquid crystal display (LCD) method, a digital light processing (DLP) method, a laser method, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into a one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x and y axes.

Meanwhile, the projection part 112 may include various types of light sources. For example, the projection part 112 may include at least one light source among a lamp, LEDs, and laser.

The projection part 112 may output an image in a screen ratio of 4:3, a screen ratio of 5:4, and a wide screen ratio of 16:9 according to the use of the electronic apparatus 100 or the user’s setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

Meanwhile, the projection part 112 may perform various functions for adjusting an output image by control by the processor 111. For example, the projection part 112 may perform functions such as zoom, keystone, quick corner (four corner) keystone, lens shift, etc.

Specifically, the projection part 112 may enlarge or reduce an image according to a distance from a screen (a projection distance). In other words, a zoom function may be performed according to a distance from a screen. Here, the zoom function may include a hardware method of adjusting the size of a screen by moving a lens and a software method of adjusting the size of a screen by a crop, etc. Meanwhile, when the zoom function is performed, adjustment of a focus of an image is needed. For example, methods of adjusting a focus include a manual focus method, an electric method, etc. The manual focus method means a method of adjusting a focus manually, and the electric method means a method wherein, when the zoom function is performed, the projector automatically adjusts a focus by using a built-in motor. When performing the zoom function, the projection part 112 may provide a digital zoom function through software, and also provide an optical zoom function of performing a zoom function by moving the lens through the driver 120.

Also, the projection part 112 may perform a keystone correction function. A screen may be distorted in an upper direction or a lower direction if the height is not matched in front surface projection. The keystone correction function means a function of correcting a distorted screen. For example, if a distortion occurs in a left-right direction of a screen, the screen may be corrected by using horizontal keystone, and if a distortion occurs in an up-down direction, the screen may be corrected by using vertical keystone. The quick corner (four corner) keystone correction function is a function of correcting a screen in case the central area of the screen is normal, but the corner areas are out of balance. The lens shift function is a function of moving a screen as it is in case the screen is beyond the range of the screen.

Meanwhile, the projection part 112 may analyze the ambient environment and a projection environment automatically without a user input, and perform zoom/keystone/focus functions. Specifically, the projection part 112 may provide zoom/keystone/focus functions automatically based on the distance between the electronic apparatus 100 and the screen detected through a sensor (a depth camera, a distance sensor, an infrared sensor, an illumination sensor, etc.), information about the space wherein the electronic apparatus 100 is currently located, information about the ambient light amount, etc.

In particular, the projection part 112 may provide an illumination function by using a light source. In particular, the projection part 112 may provide an illumination function by outputting a light source by using LEDs. According to various embodiments, the projection part 112 may include one LED, and according to another embodiment, the electronic apparatus 100 may include a plurality of LEDs. Meanwhile, the projection part 112 may output a light source by using a surface emitting LED depending on implementation examples. Here, a surface emitting LED may mean an LED having a structure wherein an optical sheet is arranged on the upper side of the LED such that a light source is evenly dispersed and output. Specifically, if a light source is output through an LED, the light source may be evenly dispersed through an optical sheet, and the light source dispersed through the optical sheet may be incident on a display panel.

Meanwhile, the projection part 112 may provide a dimming function for adjusting the strength of a light source to the user. Specifically, if a user input for adjusting the strength of a light source is received from the user through the manipulation interface 115 (e.g., a touch display button or a dial), the projection part 112 may control the LEDs to output the strength of the light source corresponding to the received user input.

Also, the projection part 112 may provide the dimming function based on a content analyzed by the processor 111 without a user input. Specifically, the projection part 112 may control the LEDs to output the strength of a light source based on information about the currently provided content (e.g., the content type, the content brightness, etc.).

Meanwhile, the projection part 112 may control the color temperature by control by the processor 111. Here, the processor 111 may control the color temperature based on a content. Specifically, if it is identified that a content is to be output, the processor 111 may obtain the color information for each frame of the content of which output has been determined. Then, the processor 111 may adjust the color temperature based on the obtained color information for each frame. Here, the processor 111 may obtain at least one main color of the frames based on the color information for each frame. Then, the processor 111 may adjust the color temperature based on the obtained at least one main color. For example, the color temperature that can be adjusted by the processor 111 may be divided into a warm type or a cold type. Here, it is assumed that a frame to be output (referred to as an output frame hereinafter) includes a scene wherein fire broke out. The processor 111 may identify (or obtain) that the main color is a red color based on the color information included in the current output frame. Then, the processor 111 may identify a color temperature corresponding to the identified main color (red). Here, the color temperature corresponding to the red color may be the warm type. Meanwhile, the processor 111 may use an artificial intelligence model for obtaining the color information or the main color of a frame. According to various embodiments, the artificial intelligence model may be stored in the electronic apparatus 100 (e.g., the memory 113). According to another embodiment, the artificial intelligence model may be stored in an external server that can communicate with the electronic apparatus 100.

Also, the projection part 112 can obviously include a light source for implementing a short throw projector.

The memory 113 may be implemented as internal memory such as ROM (e.g., electrically erasable programmable read-only memory (EEPROM)), RAM, etc., included in the processor 111, or implemented as separate memory from the processor 111. In this case, the memory 113 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

Meanwhile, in the case of memory embedded in the electronic apparatus 100, it may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)), etc. Also, in the case of memory that can be attached to or detached from the electronic apparatus 100, it may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

In the memory 113, at least one instruction regarding the electronic apparatus 100 may be stored. Also, in the memory 113, an operating system (O/S) for operating the electronic apparatus 100 may be stored. In addition, in the memory 113, various types of software programs or applications for the electronic apparatus 100 to operate according to the various embodiments of the disclosure may be stored. Further, the memory 113 may include semiconductor memory such as flash memory, etc., or a magnetic storage medium such as a hard disk, etc.

Specifically, in the memory 113, various types of software modules for the electronic apparatus 100 to operate according to the various embodiments of the disclosure may be stored, and the processor 111 may control the operations of the electronic apparatus 100 by executing the various types of software modules stored in the memory 113. In other words, the memory 113 may be accessed by the processor 111, and reading/recording/correction/deletion/update, etc. of data by the processor 111 may be performed.

Meanwhile, in the disclosure, the term memory 113 may be used as a meaning including a storage part, ROM (not shown) and RAM (not shown) inside the processor 111, or a memory card (not shown) (e.g., a micro SD card, a memory stick) installed on the electronic apparatus 100.

The communication interface 114 is a component that performs communication with various types of external devices according to various types of communication methods. The communication interface 114 may include a wireless communication module or a wired communication module. Here, each communication module may be implemented in the form of at least one hardware chip.

A wireless communication module may be a module that communicates with an external device wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra wide-band (UWB) module.

In case the neural network model is stored in an external server (or an external device), the communication interface 114 may transmit a sensing value obtained through the at least one sensor 121 to the external server (or the external device), and receive information about a driving state from the external server (or the external device).

The manipulation interface 115 may include various types of input devices. For example, the manipulation interface 115 may include physical buttons. Here, the physical buttons may include function keys, direction keys (e.g., four direction keys), or dial buttons. According to various embodiments, the physical buttons may be implemented as a plurality of keys. According to another embodiment, the physical button may be implemented as one key. Here, in case the physical buttons are implemented as one key, the electronic apparatus 100 may receive a user input by which one key is pushed during a threshold time or longer. If a user input by which one key is pushed during a threshold time or longer is received, the processor 111 may perform a function corresponding to the user input. For example, the processor 111 may provide an illumination function based on the user input.

Also, the manipulation interface 115 may receive a user input by using a non-contact method. In the case of receiving a user input through a contact method, physical force should be transmitted to the electronic apparatus 100. Accordingly, a method for controlling the electronic apparatus 100 regardless of physical force may be needed. Specifically, the manipulation interface 115 may receive a user gesture, and perform an operation corresponding to the received user gesture. Here, the manipulation interface 115 may receive a user’s gesture through a sensor (e.g., an image sensor or an infrared sensor).

In addition, the manipulation interface 115 may receive a user input by using a touch method. For example, the manipulation interface 115 may receive a user input through a touch sensor. According to various embodiments, the touch method may be implemented as a non-contact method. For example, the touch sensor may determine whether the user’s body approached within a threshold distance. Here, the touch sensor may identify a user input even when the user does not contact the touch sensor. Meanwhile, according to another implementation example, the touch sensor may identify a user input by which the user contacts the touch sensor.

Meanwhile, the electronic apparatus 100 may receive a user input by various methods other than the aforementioned manipulation interface 115. According to various embodiments, the electronic apparatus 100 may receive a user input through an external remote control device. Here, the external remote control device may be a remote control device corresponding to the electronic apparatus 100 (e.g., a dedicated control device of the electronic apparatus 100) or the user’s portable communication device (e.g., a smartphone or a wearable device). Here, in the user’s portable communication device, an application for controlling the electronic apparatus 100 may be stored. The portable communication device may obtain a user input through a stored application, and transmit the obtained user input to the electronic apparatus 100. The electronic apparatus 100 may receive a user input from the portable communication device, and perform an operation corresponding to a control command of the user.

Meanwhile, the electronic apparatus 100 may receive a user input by using voice recognition. According to various embodiments, the electronic apparatus 100 may receive a user voice through the microphone included in the electronic apparatus 100. According to another embodiment, the electronic apparatus 100 may receive a user voice from the microphone or an external device. Specifically, an external device may obtain a user voice through a microphone of the external device, and transmit the obtained user voice to the electronic apparatus 100. A user voice transmitted from the external device may be audio data or digital data converted from audio data (e.g., audio data converted to a frequency domain, etc.). Here, the electronic apparatus 100 may perform an operation corresponding to the received user voice. Specifically, the electronic apparatus 100 may receive audio data corresponding to the user voice through the microphone. Then, the electronic apparatus 100 may convert the received audio data into digital data. Then, the electronic apparatus 100 may convert the converted digital data into text data by using a speech to text (STT) function. According to various embodiments, the speech to text (STT) function may be directly performed at the electronic apparatus 100, and according to another embodiment, the speech to text (STT) function may be performed at an external server. The electronic apparatus 100 may transmit digital data to the external server. The external server may convert the digital data into text data, and obtain control command data based on the converted text data. The external server may transmit the control command data (here, the text data may also be included) to the electronic apparatus 100. The electronic apparatus 100 may perform an operation corresponding to the user voice based on the obtained control command data.

Meanwhile, the electronic apparatus 100 may provide a voice recognition function by using one assistance (or an artificial intelligence agent, e.g., Bixby^{TM}, etc.), but this is merely one of various examples, and the electronic apparatus 100 may provide the voice recognition function through a plurality of assistances. Here, the electronic apparatus 100 may provide the voice recognition function by selecting one of the plurality of assistances based on a trigger word corresponding to the assistance or a specific key existing on a remote control.

Meanwhile, the electronic apparatus 100 may receive a user input by using a screen interaction. A screen interaction may mean a function by which the electronic apparatus 100 identifies whether a predetermined event occurs through an image projected on a screen (or a projection surface), and obtains a user input based on the predetermined event. Here, the predetermined event may mean an event wherein a predetermined object is identified in a specific location (e.g., a location wherein a UI for receiving a user input was projected). Here, the predetermined object may include at least one of a body part of the user (e.g., a finger), a pointer, or a laser point. If the predetermined object is identified in the location corresponding to the projected UI, the electronic apparatus 100 may identify that a user input selecting the projected UI was received. For example, the electronic apparatus 100 may project a guide image such that a UI is displayed on the screen. Then, the electronic apparatus 100 may identify whether the user selects the projected UI. Specifically, if the predetermined object is identified in the location of the projected UI, the electronic apparatus 100 may identify that the user selected the projected UI. Here, the projected UI may include at least one item. Here, the electronic apparatus 100 may perform space analysis for identifying whether the predetermined event is in the location of the projected UI. Here, the electronic apparatus 100 may perform space analysis through the sensor (e.g., the image sensor, the infrared sensor, the depth camera, the distance sensor, etc.). The electronic apparatus 100 may identify whether the predetermined event occurs in the specific location (the location wherein the UI was projected) by performing space analysis. Then, if it is identified that the predetermined event occurs in the specific location (the location wherein the UI was projected), the electronic apparatus 100 may identify that a user input for selecting the UI corresponding to the specific location was received.

In particular, the manipulation interface 115 may receive input of a user command for generating the second map or the third map.

The input/output interface 116 is a component for inputting or outputting at least one of an audio signal or an image signal. The input/output interface 116 may receive input of at least one of an audio signal or an image signal from the external device, and output a control command to the external device.

Depending on implementation examples, the input/output interface 116 may be implemented as an interface inputting or outputting only audio signals and an interface inputting or outputting only image signals, or implemented as one interface inputting or outputting both audio signals and image signals.

Meanwhile, the input/output interface 116 according to the various embodiments of the disclosure may be implemented as at least one wired input/output interface among a high definition multimedia interface (HDMI), a mobile high-definition link (MHL), a universal serial bus (USB), a USB C-type, a display port (DP), a Thunderbolt, a video graphics array (VGA) port, an RGB port, a D-subminiature (D-SUB), or a digital visual interface (DVI). According to various embodiments, the wired input/output interface may be implemented as an interface inputting or outputting only audio signals and an interface inputting or outputting only image signals, or implemented as one interface inputting or outputting both audio signals and image signals.

Also, the electronic apparatus 100 may receive data through the wired input/output interface, but this is merely one of various examples, and the electronic apparatus 100 may be supplied with power through the wired input/output interface. For example, the electronic apparatus 100 may be supplied with power from an external battery through a USB C-type, or supplied with power from a consent through a power adaptor. As another example, the electronic apparatus 100 may be supplied with power from an external device (e.g., a laptop or a monitor, etc.) through a DP.

Meanwhile, the electronic apparatus 100 may be implemented such that an audio signal is input through a wired input/output interface, and an image signal is input through a wireless input/output interface (or a communication interface). Alternatively, the electronic apparatus 100 may be implemented such that an audio signal is input through a wireless input/output interface (or a communication interface), and an image signal is input through a wired input/output interface.

The speaker 117 is a component that outputs audio signals. In particular, the speaker 117 may include an audio output mixer, an audio signal processor, and an audio output module. The audio output mixer may synthesize a plurality of audio signals to be output into at least one audio signal. For example, the audio output mixer may synthesize an analog audio signal and another analog audio signal (e.g.: an analog audio signal received from the outside) into at least one analog audio signal. The audio output module may include a speaker or an output terminal. According to various embodiments, the audio output module may include a plurality of speakers, and in this case, the audio output module may be arranged inside the main body, and audio that is emitted while covering at least a portion of the diaphragm of the audio output module may pass through a waveguide, and may be transmitted to the outside of the main body. The audio output module may include a plurality of audio output units, and as the plurality of audio output units are symmetrically arranged on the exterior of the main body, audio may be emitted in all directions, i.e., all directions in 360 degrees.

The microphone 118 is a component for receiving input of a user voice or other sounds, and converting them into audio data. The microphone 118 may receive a user’s voice in an activated state. For example, the microphone 118 may be formed as an integrated type on the upper side or the front surface direction, the side surface direction, etc. of the electronic apparatus 100. The microphone 118 may include various components such as a microphone collecting a user voice in an analog form, an amp circuit amplifying the collected user voice, an A/D conversion circuit that samples the amplified user voice and converts the user voice into a digital signal, a filter circuit that removes noise components from the converted digital signal, etc.

The power part 119 may be provided with power from the outside, and provide the power to the various components of the electronic apparatus 100. The power part 119 according to the various embodiments of the disclosure may be provided with power through various methods. According to the various embodiments, the power part 119 may be provided with power by using a connector. Also, the power part 119 may be provided with power by using a DC power code of 220V. However, the disclosure is not limited thereto, and the electronic apparatus 100 may be provided with power by using a USB power code, or provided with power by using a wireless charging method.

Also, the power part 119 may be provided with power by using an internal battery or an external battery. The power part 119 according to the various embodiments of the disclosure may be provided with power through an internal battery. As an example, the power part 119 may charge the power of the internal battery by using at least one of a DC power code of 220V, a USB power code, or a USB C-type power code, and may be provided with power through the charged internal battery. In addition, the power part 119 according to the various embodiments of the disclosure may be provided with power through an external battery. As an example, if connection between the electronic apparatus 100 and the external battery is performed through various wired communication methods such as a USB power code, a USB C-type power code, a socket groove, etc., the power part 119 may be provided with power through the external battery. In other words, the power part 119 may be directly provided with power from the external battery, or charge the internal battery through the external battery, and may be provided with power from the charged internal battery.

The power part 119 according to the disclosure may be provided with power by using at least one of the plurality of aforementioned power supply methods.

Meanwhile, regarding power consumption, the electronic apparatus 100 may have power consumption lower than or equal to a predetermined value (e.g., 43W) for reasons such as a socket form and other standards, etc. Here, the electronic apparatus 100 may vary the power consumption so that power consumption can be reduced when using the battery. In other words, the electronic apparatus 100 may vary the power consumption based on a power supply method and a power use amount, etc.

The driver 120 may drive at least one hardware component included in the electronic apparatus 100. The driver 120 may generate physical force, and transmit the force to at least one hardware component included in the electronic apparatus 100.

Here, the driver 120 may generate driving power for an operation of moving a hardware component included in the electronic apparatus 100 (e.g., moving of the electronic apparatus 100) or rotating a component (e.g., rotating of the projection lens).

The driver 120 may adjust a projection direction (or a projection angle) of the projection part 122. Also, the driver 120 may move the location of the electronic apparatus 100. Here, the driver 120 may control the moving element 109 for moving the electronic apparatus 100. For example, the driver 120 may control the moving element 109 by using a motor and a wheel.

The at least one sensor 121 may include various types of sensors. Specifically, the at least one sensor 121 may include at least one of a tilt sensor that senses a tilt of the electronic apparatus 100 or an image sensor that photographs an image. Here, the tilt sensor may be an acceleration sensor or a gyro sensor, and the image sensor may mean a camera or a depth camera. Meanwhile, the tilt sensor may also be described as a movement sensor. Also, the at least one sensor 121 may include various sensors other than the tilt sensor or the image sensor. For example, the at least one sensor 121 may include an illumination sensor and a distance sensor. The distance sensor may be a Time of Flight (ToF) sensor. Also, the at least one sensor 121 may include a LiDAR sensor.

Meanwhile, the electronic apparatus 100 may control the illumination function by being interlocked with an external device. Specifically, the electronic apparatus 100 may receive illumination information from an external device. Here, the illumination information may include at least one of brightness information or color temperature information set in the external device. Here, the external device may mean a device connected to the same network as the electronic apparatus 100 (e.g., an IoT device included in the same home/company network) or a device that is not connected to the same network as the electronic apparatus 100 but can communicate with the electronic apparatus 100 (e.g., a remote control server). For example, it is assumed that an external illumination device (an IoT device) included in the same network as the electronic apparatus 100 is outputting a red lighting at the brightness of 50. The external illumination device (an IoT device) may directly or indirectly transmit illumination information (e.g., information that the red lighting is being output at the brightness of 50) to the electronic apparatus 100. Here, the electronic apparatus 100 may control an output of a light source based on the illumination information received from the external illumination device. For example, if the illumination information received from the external illumination device includes information that the red lighting is being output at the brightness of 50, the electronic apparatus 100 may output the red lighting at the brightness of 50.

Meanwhile, the electronic apparatus 100 may control the illumination function based on biometric information. Specifically, the processor 111 may obtain the biometric information of the user. Here, the biometric information may include at least one of the body temperature, the heart rate, the blood pressure, the breathing, or the electrocardiogram of the user. Here, the biometric information may include various kinds of information other than the aforementioned information. As an example, the electronic apparatus 100 may include a sensor for measuring biometric information. The processor 111 may obtain the biometric information of the user through the sensor, and control an output of a light source based on the obtained biometric information. As another example, the processor 111 may receive biometric information from an external device through the input/output interface 116. Here, the external device may mean a portable communication device (e.g., a smartphone or a wearable device) of the user. The processor 111 may obtain the biometric information of the user from the external device, and control an output of a light source based on the obtained biometric information. Meanwhile, depending on implementation examples, the electronic apparatus 100 may identify whether the user is sleeping, and if it is identified that the user is sleeping (or is preparing to sleep), the processor 111 may control an output of a light source based on the biometric information of the user.

Meanwhile, the electronic apparatus 100 according to the various embodiments of the disclosure may provide various smart functions.

Specifically, the electronic apparatus 100 may be connected with a portable terminal device for controlling the electronic apparatus 100, and the screen output from the electronic apparatus 100 may be controlled through a user input that is input into the portable terminal device. As an example, the portable terminal device may be implemented as a smartphone including a touch display, and the electronic apparatus 100 may receive screen data provided at the portable terminal device from the portable terminal device and output the screen, and the screen output from the electronic apparatus 100 may be controlled according to a user input that is input into the portable terminal device.

The electronic apparatus 100 may perform connection with a portable terminal device through various communication methods such as Miracast, Airplay, wireless DEX, a remote PC method, etc., and share contents or music provided at the portable terminal device.

Also, connection between a portable terminal device and the electronic apparatus 100 may be performed by various connection methods. According to various embodiments, a portable terminal device may search the electronic apparatus 100 and perform wireless connection, or the electronic apparatus 100 may search the portable terminal device and perform wireless connection. Then, the electronic apparatus 100 may output contents provided at the portable terminal device.

According to various embodiments, while a specific content or music is being output at a portable terminal device, if the portable terminal device is located near the electronic apparatus 100, and then a predetermined gesture (e.g., a motion tap view) is detected through the display of the portable terminal device, the electronic apparatus 100 may output the content or the music that is being output at the portable terminal device.

According to various embodiments, while a specific content or music is being output at a portable terminal device, if the portable terminal device becomes close to the electronic apparatus 100 within a predetermined distance or shorter (e.g., a non-contact tap view), or the portable terminal device contacts the electronic apparatus 100 at a short interval twice (e.g., a contact tap view), the electronic apparatus 100 may output the content or the music that is being output at the portable terminal device.

In the aforementioned embodiments, it was explained that the same screen as the screen that is being provided at a portable terminal device is provided at the electronic apparatus 100, but the disclosure is not limited thereto. In other words, if connection between a portable terminal device and the electronic apparatus 100 is constructed, a first screen provided at the portable terminal device may be output at the portable terminal device, and a second screen provided at the portable terminal device different from the first screen may be output at the electronic apparatus 100. As an example, the first screen may be a screen provided by a first application installed in the portable terminal device, and the second screen may be a screen provided by a second application installed in the portable terminal device. As an example, the first screen and the second screen may be different screens provided by one application installed in the portable terminal device. As an example, the first screen may be a screen including a UI in a remote control format for controlling the second screen.

The electronic apparatus 100 according to the disclosure may output a standby screen. As an example, in case connection of the electronic apparatus 100 with an external device was not performed or there is no input received from the external device during a predetermined time, the electronic apparatus 100 may output a standby screen. Conditions for the electronic apparatus 100 to output a standby screen are not limited to the aforementioned example, and a standby screen may be output by various conditions.

The electronic apparatus 100 may output a standby screen in a form of a blue screen, but the disclosure is not limited thereto. As an example, the electronic apparatus 100 may extract only a form of a specific object from data received from an external device and obtain an atypical object, and output a standby screen including the obtained atypical object.

Meanwhile, the electronic apparatus 100 may further include a display (not shown).

The display (not shown) may be implemented as displays in various forms such as a liquid crystal display (LCD), an organic light emitting diodes (OLED) display, a plasma display panel (PDP), etc. Inside the display (not shown), driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display (not shown) may be implemented as a touch screen combined with a touch sensor, a flexible display, a three-dimensional (3D) display, etc. Also, the display (not shown) according to the various embodiments of the disclosure may include not only a display panel outputting images, but also a bezel housing the display panel. In particular, a bezel according to the various embodiments of the disclosure may include a touch sensor (not shown) for detecting user interactions.

Meanwhile, the electronic apparatus 100 may further include a shutter part (not shown).

The shutter part (not shown) may include at least one of a shutter, a fixing element, a rail, or a body.

Here, the shutter may block light output from the projection part 112. Here, the fixing element may fix the location of the shutter. Here, the rail may be a route through which the shutter and the fixing element are moved. Here, the body may be a component including the shutter and the fixing element.

The processor 111 may be implemented as a digital signal processor (DSP) processing digital signals, a microprocessor, and a time controller (TCON). However, the disclosure is not limited thereto, and the processor 111 may include one or more of a central processing unit (CPU), a micro controller unit (MCU), a micro processing unit (MPU), a controller, an application processor (AP), a graphics-processing unit (GPU), or a communication processor (CP), and an advanced reduced instruction set computer (RISC) machines (ARM) processor, or may be defined by the terms. Also, the processor 111 may be implemented as a system on chip (SoC) having a processing algorithm stored therein or large scale integration (LSI), or in the form of a field programmable gate array (FPGA). Further, the processor 111 may perform various functions by executing computer executable instructions stored in the memory 113.

In particular, the processor 111 may control the operations of the electronic apparatus 100 by executing the at least one instruction stored in the memory 113.

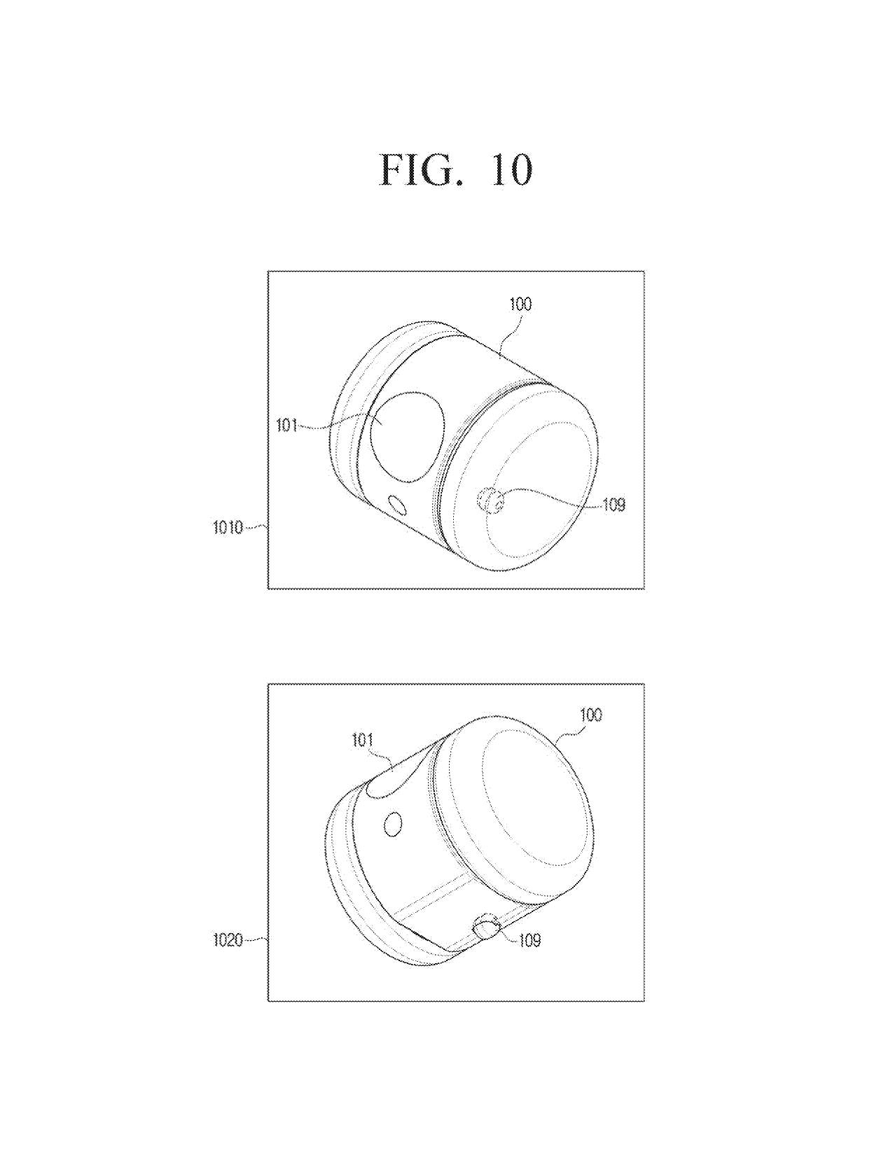

FIG. 10 is a perspective view illustrating the exterior of an electronic apparatus according to an embodiment of the disclosure. Referring to the embodiment 1010 in FIG. 10, the electronic apparatus 100 may include a moving element 109. The moving element 109 may mean an element for moving from the first location to the second location in the space wherein the electronic apparatus 100 is arranged. The electronic apparatus 100 may control the moving element 109 such that the electronic apparatus 100 is moved by using force generated in the driver 120. Here, the moving element 109 may include a motor or a wheel. The embodiment 1020 in FIG. 10 is a diagram that viewed the electronic apparatus 100 in the embodiment 1010 in a different direction.

Meanwhile, a method according to the various embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed directly on-line (e.g.: download or upload) through an application store (e.g.: Play Store^{TM}), or between two user devices (e.g.: smartphones). In the case of on-line distribution, at least a portion of a computer program product (e.g.: a downloadable app) may be stored in a storage medium readable by machines such as the server of the manufacturer, the server of the application store, and the memory of the relay server at least temporarily, or may be generated temporarily.

Also, the method according to the various embodiments of the disclosure may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments (e.g., a TV).

Meanwhile, a storage medium readable by machines may be provided in the form of a non-transitory storage medium. Here, the term ‘a non-transitory storage medium’ only means that the storage medium is a tangible device, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

In case an instruction is executed by a processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
at least one sensor;
a driver;
memory storing at least one instruction; and
one or more processors operatively connected to the at least one sensor, the driver, and the memory,
wherein at least one instruction, when executed by the one or more processors individually or collectively, causes the electronic apparatus to:
identify whether the electronic apparatus was lifted while the electronic apparatus is operating in a first driving state based on a first map of an area where the electronic apparatus is located;
based on the electronic apparatus being lifted while the electronic apparatus is operating in the first driving state, obtain information about a height at which the electronic apparatus is placed after being lifted based on a sensing value obtained from the at least one sensor, and
based on the height being within a first range, operate in a second driving state, wherein a speed of the electronic apparatus is limited to less than a first value in the second driving state.

2. The electronic apparatus of claim 1,
wherein the at least one instruction, when executed by the one or more processors individually or collectively, causes the electronic apparatus to:
while the electronic apparatus is moving after being lifted, obtain first information about a location to which the electronic apparatus moved based on the sensing value obtained from the at least one sensor, and
based on the electronic apparatus being placed, identify the location to which the electronic apparatus moved based on the obtained first information.

3. The electronic apparatus of claim 2,
wherein the at least one sensor comprises:
an inertial measurement unit (IMU) sensor and a bottom surface detection sensor, and
wherein the at least one instruction, when executed by the one or more processors individually or collectively, causes the electronic apparatus to:
while operating in the second driving state, identify whether the first map for a space in which the electronic apparatus is placed is stored in the memory based on the first information about the location, and
based on the first map being identified as not stored in the memory, generate a second map for the space based on sensing values obtained through the IMU sensor and the bottom surface detection sensor while the electronic apparatus is moving in the space.

4. The electronic apparatus of claim 3,
wherein the at least one instruction, when executed by the one or more processors individually or collectively, causes the electronic apparatus to:
match information about the second map generated based on the first information about the location with the first map and store the information about the second map in the memory.

5. The electronic apparatus of claim 3,
wherein the at least one instruction, when executed by the one or more processors individually or collectively, causes the electronic apparatus to:
while operating in the second driving state, control the driver to move at the speed less than the first value within the space based on information about the second map.

6. The electronic apparatus of claim 3, further comprising:
a projection part comprising a short throw projector,
wherein the at least one instruction, when executed by the one or more processors individually or collectively, causes the electronic apparatus to:
while operating in the second driving state, control the projection part to project a screen by using the short throw projector in the space.

7. The electronic apparatus of claim 1,
wherein the at least one instruction, when executed by the one or more processors individually or collectively, causes the electronic apparatus to:
based on the height being within a second range higher than the first range, operate in a third driving state, wherein the electronic apparatus moves based on a third map corresponding to the height in the third driving state.

8. The electronic apparatus of claim 7,
wherein the at least one instruction, when executed by the one or more processors individually or collectively, causes the electronic apparatus to:
identify whether information about the third map is stored in the memory; and
based on the information about the third map being identified as not stored in the memory, generate the third map for a space in which the electronic apparatus is placed based on the sensing value obtained from the at least one sensor while the electronic apparatus is moving in the space.

9. The electronic apparatus of claim 1,
wherein the at least one instruction, when executed by the one or more processors individually or collectively, causes the electronic apparatus to:
obtain information about a driving state according to the height by inputting the sensing value obtained from the at least one sensor into a trained neural network model.

10. A control method for an electronic apparatus, the method comprising:
operating in a first driving state, wherein the electronic apparatus moves based on a first map of an area where the electronic apparatus is located in the first driving state;
identifying whether the electronic apparatus was lifted while the electronic apparatus is operating in the first driving state;
based on identifying that the electronic apparatus was lifted while the electronic apparatus is operating in the first driving state, obtaining information about a height at which the electronic apparatus is placed after being lifted based on a sensing value obtained from at least one sensor; and
based on the height being within a first range, operating in a second driving state, wherein a speed of the electronic apparatus is limited to less than a first value in the second driving state.

11. The control method of claim 10, further comprising:
while the electronic apparatus is moving after being lifted, obtaining first information about a location to which the electronic apparatus moved based on the sensing value obtained from the at least one sensor; and
based on the electronic apparatus being placed, identifying the location to which the electronic apparatus moved based on the obtained first information.

12. The control method of claim 11,
wherein the at least one sensor comprises:
an IMU sensor and a bottom surface detection sensor, and
wherein the control method comprises:
while operating in the second driving state, identifying whether the first map for a space in which the electronic apparatus is placed is stored in a memory of the electronic apparatus based on the first information about the location; and
based on identifying that the first map is not stored in the memory, generating a second map for the space based on sensing values obtained through the IMU sensor and the bottom surface detection sensor while the electronic apparatus is moving in the space.

13. The control method of claim 12, further comprising:
matching information about the second map generated based on the first information about the location with the first map and storing the information about the second map in the memory.

14. The control method of claim 12, further comprising:
while operating in the second driving state, moving at the speed less than the first value within the space based on information about the second map.

15. The control method of claim 12, further comprising:
while operating in the second driving state, projecting a screen by using a short throw projector of the electronic apparatus in the space wherein the electronic apparatus is placed.

16. The control method of claim 10, further comprising:
based on the height being within a second range higher than the first range, operating in a third driving state, wherein the electronic apparatus moves based on a third map corresponding to the height in the third driving state.

17. The control method of claim 16, further comprising:
identifying whether information about the third map is stored in a memory of the electronic apparatus; and
based on identifying that the information about the third map is not stored in the memory, generate the third map for a space in which the electronic apparatus is placed based on the sensing value obtained from the at least one sensor while the electronic apparatus is moving in the space.

18. The method of claim 10, further comprising:
inputting the sensing value obtained from the at least one sensor into a trained neural network; and
obtaining information about a driving state according to the height based on the inputting the sensing value obtained from the at least one sensor into the trained neural network model.

19. The method of claim 10, further comprising:
identifying whether the height has changed;
based on identifying that the height has changed, identifying whether the height is within the first range; and
based on identifying that the height is not within the first range, operating in a third driving state, wherein the electronic apparatus moves based on a third map corresponding to the height in the third driving state.

20. A non-transitory computer-readable medium storing instructions that, when executed by a processor of an electronic apparatus, cause the electronic apparatus to:
operate in a first driving state, wherein the electronic apparatus moves based on a first map of an area in which the electronic apparatus is located in the first driving state;
identify whether the electronic apparatus was lifted while the electronic apparatus is operating in the first driving state;
based on identifying that the electronic apparatus was lifted while the electronic apparatus is operating in the first driving state, obtain information about a height at which the electronic apparatus is placed after being lifted based on a sensing value obtained from at least one sensor; and
based on the height being within a first range, operate in a second driving state, wherein a speed of the electronic apparatus is limited to less than a first value in the second driving state.
